(19) United States
(12) Patent Application Publication
(10) Pub. No.: US 2022/0027693 A1
(43) Pub. Date: Jan. 27, 2022

(54) PRINTER AND CONTROL METHOD FOR PRINTER

(71) Applicant: SEIKO EPSON CORPORATION, Tokyo (JP)

(72) Inventors: Shinya FUKUSHIMA, Shiojiri-shi (JP); Tomohito Someya, Shiojiri-shi (JP)

(21) Appl. No.: 17/381,974

(22) Filed: Jul. 21, 2021

(30) Foreign Application Priority Data
Jul. 23, 2020 (JP) 2020-125890

(51) Int. Cl. G06K 15/00; G06K 15/02

(52) U.S. Cl. CPC G06K 15/4055; G06K 15/028; G06K 15/024

(57) ABSTRACT

A printer includes a power supply section, a first communication section configured to make wired communication with a first smart device having a battery and supply power from the power supply section to the first smart device, a printing section that performs printing, and a control section, and the control section acquires temperature information, acquires remaining amount information of the battery from the first smart device using the first communication section, dynamically changes a threshold value based on the acquired temperature information in a range less than the maximum value of the remaining amount information, executes a first mode in which power is supplied from the power supply section to the first smart device via the first communication section when the remaining amount information is less than the threshold value, and executes a second mode in which power is not supplied from the power supply section to the first smart device via the first communication section for a predetermined period when the remaining amount information is equal to or more than the threshold value.

The present application is based on, and claims priority from JP Application Serial Number 2020-125890, filed Jul. 23, 2020, the disclosure of which is hereby incorporated by reference herein in its entirety.

### BACKGROUND

### 1. Technical Field

The present disclosure relates to a printer and a control method for a printer.

### 2. Related Art

Recently, information processing units that perform communications with portable communication terminals and power supply for charging have become widely used. As shown in JP-A-2015-144519, the information processing unit supplies power to the portable communication terminal when the value of the remaining amount of the battery of the portable communication terminal is smaller than a predetermined upper limit value and shuts off the power supply to the portable communication terminal when the value is equal to or larger than the predetermined upper limit value.

However, in the information processing unit disclosed in JP-A-2015-144519, the temperature when the battery is charged is not considered and the battery may be deteriorated.

### SUMMARY

A printer includes a power supply section, a first communication section configured to make wired communication with a first terminal device having a battery and supply power from the power supply section to the first terminal device, and a control section, and the control section acquires temperature information, changes a threshold value based on the acquired temperature information, acquires remaining amount information of the battery from the first terminal device using the first communication section, executes a first mode in which power is supplied from the power supply section to the first terminal device via the first communication section when the remaining amount information is less than the threshold value, and executes a second mode in which power is not supplied from the power supply section to the first terminal device via the first communication section when the remaining amount information is equal to or more than the threshold value.

A control method for a printer including a power supply section, a first communication section configured to make wired communication with a first terminal device having a battery and supply power from the power supply section to the first terminal device, and a printing section that performs printing, the method including acquiring temperature information, changing a threshold value based on the acquired temperature information, acquiring remaining amount information of the battery from the first terminal device using the first communication section, executing a first mode in which power is supplied from the power supply section to the first terminal device via the first communication section when the remaining amount information is less than the threshold value, and executing a second mode in which power is not supplied from the power supply section to the first terminal device via the first communication section when the remaining amount information is equal to or more than the threshold value.

### BRIEF DESCRIPTION OF THE DRAWINGS

FIG. 1 is a block diagram showing a configuration of a printer according to embodiment 1.

FIG. 2 is a flowchart showing a control method for the printer according to embodiment 1.

FIG. 3 is a table showing temperature information of a battery and threshold values.

FIG. 4 is a graph showing a relationship between the temperature information of the battery and the threshold value.

FIG. 5 is a graph showing transitions of a first mode and a second mode.

FIG. 6 is a table showing temperature information of a temperature sensor and threshold values.

FIG. 7 is a block diagram showing a configuration of a printer according to embodiment 2.

### DESCRIPTION OF EXEMPLARY EMBODIMENTS

### 1. Embodiment 1

### 1-1. Configuration of Printer

A printer according to embodiment 1 is used for e.g. a POS (Point Of Sale) system with a smart device. The POS system is a system used for operations in retailing business including shopping centers, department stores, convenience stores, and sales in trains, and restaurant business including restaurants, coffee shops, and bars. The POS system has a function of making payment according to merchandise and service purchased by a customer, a function of issuing a receipt according to the payment, etc.

Recently, with the widespread use of smart devices as portable terminal devices, store staff often serve customers to help payment in retailing business, and waitstaff often accept payment at tables of customers in restaurant business. The store staff carry the smart devices and move within the store. When a receipt or the like for the payment is necessary, the store staff operates the smart device, transmits print data to a printer installed in the store, issues the receipt using the printer, and hands the receipt to the customer.

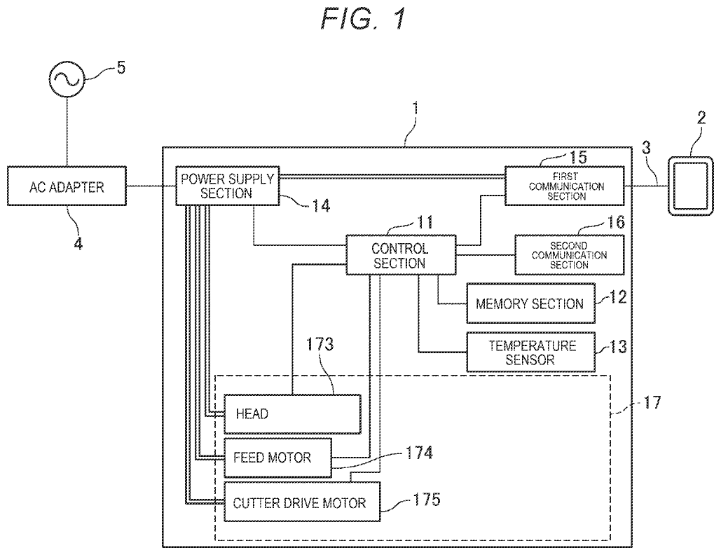

As shown in FIG. 1, a printer 1 includes a control section 11, a memory section 12, a temperature sensor 13, a power supply section 14, a first communication section 15, a second communication section 16, and a printing section 17.

The first communication section 15 is for wired communications and the second communication section 16 is for wireless communications. The printer 1 is coupled to a first smart device 2 as a first terminal device via a communication cable 3 by the first communication section 15.

The printer 1 receives power supply from an AC adapter 4 and operates. The AC adapter 4 is coupled to a commercial alternating-current power supply 5.

The control section 11 includes a CPU. The CPU is also called a processor. The control section 11 reads and executes a program such as firmware stored in the memory section 12 and controls the respective sections of the printer 1.

The printing section 17 includes a head 173, a feed motor 174, and a cutter drive motor 175.

The head 173 is a line thermal head as an example. The head 173 has a plurality of heat generating elements arranged in a line and prints characters and images by applying heat to thermal paper as a recording medium.

The feed motor 174 rotates feed rollers and a platen and feeds the thermal paper.

The thermal paper is rolled in a roll form. The cutter drive motor 175 moves a movable blade toward a fixed blade and cuts the rolled thermal paper.

The thermal paper printed by the printing section 17, fed in a predetermined length by driving of the feed motor 174, and cut by driving of the cutter drive motor 175 is issued as a receipt.

The temperature sensor 13 is a thermistor as an example. The temperature sensor 13 is placed in a position in the printer 1 apart from parts in which the temperatures rise including the control section 11, the power supply section 14, and the printing section 17, and can detect the surrounding temperature. The control section 11 can acquire temperature information using the temperature sensor 13.

The power supply section 14 is supplied with e.g. direct-current power at 24 V via a power supply cable from the AC adapter 4. The power supply section 14 includes an overcurrent protection circuit and is configured to output and supply respective voltages of 3.3 V, 5 V, 24 V to the respective sections of the printer 1 via the overcurrent protection circuit.

Specifically, the power supply section 14 supplies 24 V to actuators including the head 173, the feed motor 174 and the cutter drive motor 175 and operate the actuators. The power supply section 14 supplies 3.3 V to logic circuits including the control section 11 and operates the circuits. Further, the power supply section 14 supplies 5 V to the first communication section 15 to enable power supply at 5 V to the first smart device 2 via the first communication section 15.

The power supply section 14 has power capacity incapable of suppling power to the first smart device 2 and suppling power to the printing section 17 at the same time. Thereby, the power supply section 14 may be made smaller. As described above, the printer 1 is used in the POS system with the first smart device 2 carried and used by the store staff, and space-saving compactness is required. The power supply section 14 is made smaller, and thereby, the printer 1 may be compact.

### 1-2. Communication Between First Communication Section and First Terminal Device

The first smart device 2 is e.g. a smartphone or tablet. The first smart device 2 includes a secondary cell as a rechargeable battery and operates by the power charged in the secondary cell. Hereinafter, the secondary cell of the first smart device 2 is simply referred to as “battery”.

The first smart device 2 includes a communication section that communicates data according to a predetermined communication standard, and communicates with the printer 1 using the communication section.

The first smart device 2 creates print data using an installed application and transmits the print data and commands to the first communication section 15 of the printer 1 from the communication section in response to an instruction by a user as a trigger.

When the first communication section 15 receives the print data, the control section 11 of the printer 1 controls the head 173 and prints characters and images on the thermal paper.

For printing by the printer 1, the first smart device 2 transmits the print data with a command relating to printing. The command relating to printing is e.g. a linefeed command to instruct linefeed or a cutter command to instruct cutting of the thermal paper.

When the first communication section 15 receives the linefeed command, the control section 11 of the printer 1 feeds the thermal paper for one line by controlling the feed motor 174. When the first communication section 15 receives the cutter command, the control section 11 controls the cutter drive motor 175 to move the movable blade and cut the thermal paper.

The commands include not only the commands relating to printing but also commands relating to control. The commands relating to control include e.g. a status command for the first smart device 2 to transmit a predetermined status to the printer 1 and a request command to request the status command from the printer 1 to the first smart device 2. The status command includes remaining amount information representing the remaining amount of the battery of the first smart device 2 and temperature information representing the temperature of the battery of the first smart device 2.

1-3. Power Supply from First Communication Section to First Terminal Device

The first communication section 15 is e.g. a communication circuit including a communication IC and a connector operating according to the USB (Universal Serial Bus) standard.

The first communication section 15 includes two power lines of VBUS and GND and two data lines of D+ and D− according to the USB standard. The VBUS is the power line indicating a voltage value of 5 V. The power at 5 V is output from the power supply section 14 via the first communication section 15 under control of the control section 11. The first communication section 15 supplies power at 5 V to the first smart device 2 coupled via the communication cable 3 by the two power lines.

It is necessary to charge the battery of the first smart device 2 for the store staff carrying and using the first smart device 2. The first smart device 2 is supplied with power at 5 V from the first communication section 15 of the printer 1 and charges the battery.

The battery of the first smart device 2 is e.g. a lithium-ion battery. The performance of the lithium-ion battery is determined with reference to the surrounding temperature at 25° C. When continuously charged in a high-temperature environment, the lithium-ion battery is deteriorated. For example, the initial battery capacity at 100% becomes lower to 50% or less due to deterioration. When the lithium-ion battery is deteriorated, it is necessary for the first smart device 2 to frequently charge the battery, and the frequent charging further accelerates the deterioration and the battery finally fails.

### 1-4. Method of Controlling Power Supply by Printer 1

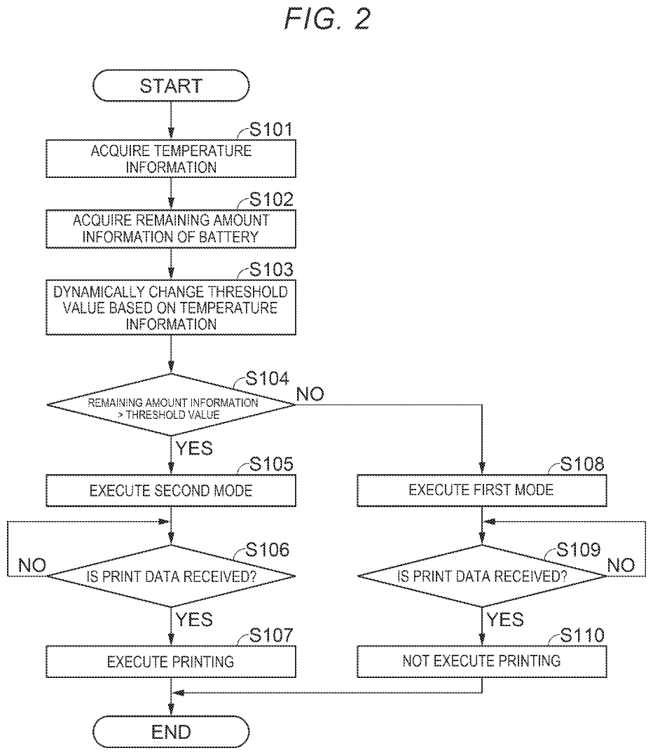

Power supply control performed on the first smart device 2 by the printer 1 will be explained using a flowchart shown in FIG. 2.

The control section 11 of the printer 1 transmits the request command to request the status command to the first smart device 2 on a regular basis using the first communication section 15. The first smart device 2 receiving the request command transmits the status command containing the remaining amount information representing the remaining amount of the battery and the temperature information representing the battery temperature to the first communication section 15. Further, in the request command, an option to transmit the status command to the first smart device 2 on the regular basis is specified. The control section 11 transmits the request command with the option to the first smart device 2 in advance. Then, the status command is transmitted on the regular basis even when the first smart device 2 does not receive the request command at each time.

The control section 11 starts control and acquires the remaining amount information and the temperature information of the battery on the regular basis from the status command received by the first communication section 15 (S101) (S102).

A temperature sensor such as a thermistor is attached to the battery, and the first smart device 2 detects the temperature of the battery and obtains the temperature information. The temperature of the battery rising at charging can be detected.

Further, the first smart device 2 measures the battery voltage using a voltage detection circuit. The battery voltage and the remaining amount have a correlation. The first smart device 2 calculates the remaining amount from the measured battery voltage and obtains the remaining amount information. The remaining amount information is indicated by a ratio when the power capacity of the fully charged battery is 100%. For example, if the power capacity of the fully charged battery is 1600 mAh, when the remaining amount of the battery calculated from the measured battery voltage is 800 mAh, the remaining amount information is 50%.

Here, the temperature information of the battery acquired from the first smart device 2 by the control section 11 is Tb and a threshold value used for determination to supply or stop power to the first smart device 2 is th.

As described above, the battery is deteriorated when continuously charged in the high temperature environment. Here, the maximum value of the remaining amount information of the battery is 100% as the power capacity of the fully charged battery. When continuously charged to the maximum value of the remaining amount information, the battery is further deteriorated.

Accordingly, the control section 11 sets the threshold value th to be smaller as the temperature information Tb of the battery is higher within a range less than the maximum value of the remaining amount information, and early stops charging of the battery.

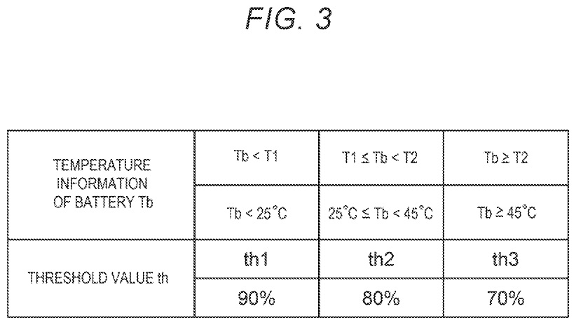

Specifically, as shown in FIG. 3, the range of the battery temperature information Tb is divided into three ranges lower than T1, equal to or higher than T1 and lower than T2, and equal to or higher than T2 from the lower temperature. In the example of FIG. 3, T1 indicates 25° C. and T2 indicates 45° C. T2 is 45° C. higher than the normal surrounding temperature in consideration of the battery temperature rising at charging. The threshold values th corresponding to the three ranges of the battery temperature information Tb are respectively e.g. 90%, 80%, 70%. The values showing the relationship between Tb and th are stored in the memory section 12.

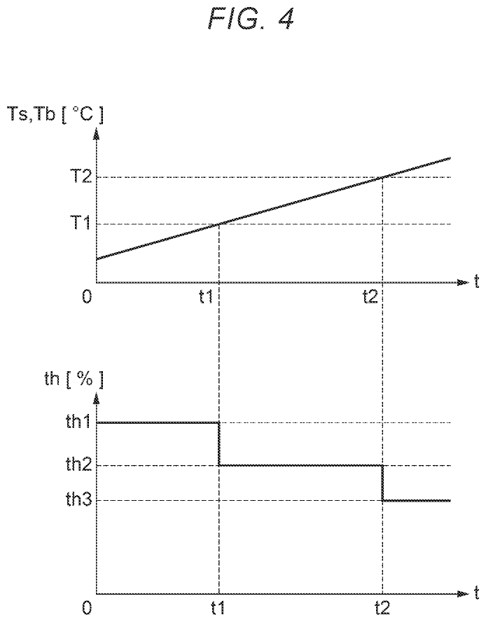

Using FIG. 4, the control section 11 dynamically changing the threshold value th based on the battery temperature information Tb is explained.

In FIG. 4, two graphs having a horizontal axis in common are shown. The vertical axis of the upper graph indicates the battery temperature information Tb, the vertical axis of the lower graph indicates the threshold value th, and the horizontal axis of the graphs indicates time t.

In FIG. 4, t=0 is the start of charging. At the start of charging, the battery temperature information Tb acquired by the control section 11 is Tb<T1, and the control section 11 sets the initial threshold value th to th1 with reference to the memory section 12. As shown in FIG. 3, th1 is 90%.

After the start of charging, the control section 11 acquires the battery temperature information Tb from the first smart device 2 on a regular basis and determines the threshold values th with reference to the memory section 12.

Referring to FIG. 4, a specific explanation will be made with the lapse of the time t.

When the time t is 0≤t<t1, the acquired battery temperature information Tb is Tb<T1, and the control section 11 sets the threshold value th to th1 with reference to the memory section 12. As described above, at t=0 at the start of charging, the threshold value th is th1, and the control section 11 does not change the threshold value th from th1.

Then, when the time t is t1≤t<t2, the acquired battery temperature information Tb is T1≤Tb<T2, and the control section 11 sets the threshold value th to th2 with reference to the memory section 12. The control section 11 changes the threshold value th from th1 to th2.

Then, when the time t is t2≤t, the acquired battery temperature information Tb is T2 Tb, and the control section 11 sets the threshold value th to th3 with reference to the memory section 12. The control section 11 changes the threshold value th from th2 to th3.

In the above described manner, the control section 11 dynamically changes the threshold value th based on the battery temperature information Tb (S103).

The control section 11 compares the remaining amount information of the battery acquired from the status command with the threshold value th determined based on the battery temperature information Tb (S104).

When determining that the remaining amount information of the battery is equal to or more than the threshold value th (S104: YES), the control section 11 executes a second mode (S105).

The second mode is a mode in which the control section 11 does not supply power from the power supply section 14 to the first smart device 2 via the first communication section 15 for a predetermined period. Specifically, the control section 11 controls the power supply section 14 to stop power at 5 V for outputting to the VBUS via the first communication section 15.

Under the above described control of the control section 11, the battery of the first smart device 2 is not charged to the remaining amount equal to or more than the threshold value th and deterioration is suppressed.

The control section 11 determines whether or not print data is received (S106). The first communication section 15 receives the print data from the first smart device 2, and then, stores the data in the memory section 12. The control section 11 may determine whether or not the print data is received by checking whether or not the print data is stored in the memory section 12. The control section 11 may determine whether or not the print data is received based on presence or absence of an interrupt signal generated when the first communication section 15 receives the print data.

When determining that the print data is received (S106: YES), the control section 11 reads the print data from the memory section 12, executes printing by controlling the printing section 17, and prints characters and images on thermal paper (S107).

In the second mode, the power supply section 14 does not supply power to the first smart device 2 and has sufficient power to operate the printing section 17. Therefore, the control section 11 may execute printing by controlling the printing section 17.

Further, in the second mode, the power supply section 14 has sufficient power. Even when receiving a linefeed command and a cutter command with the print data or in place of the print data, the control section 11 may execute feeding and cutting of the thermal paper by controlling the feed motor 174 and the cutter drive motor 175.

When determining that the print data is not received (S106: NO), the control section 11 waits for reception of the print data for a predetermined time. When the print data is not received for the predetermined time, the process exits the loop of (S106: NO) and ends the processing.

On the other hand, when determining that the remaining amount information of the battery is less than the threshold value th (S104: NO) as a result of the comparison between the remaining amount information of the battery acquired from the status command and the threshold value th determined based on the battery temperature information Tb, the control section 11 executes a first mode (S108).

The first mode is a mode in which the control section 11 supplies power from the power supply section 14 to the first smart device 2 via the first communication section 15. Specifically, the control section 11 controls the power supply section 14 to output power at 5 V to the VBUS via the first communication section 15.

Under the above described control of the control section 11, the battery of the first smart device 2 can be charged.

The control section 11 determines whether or not print data is received (S109). The control section 11 determines whether or not print data is received by checking whether or not the print data is stored in the memory section 12 or based on presence or absence of an interrupt signal of the first communication section 15.

In the first mode, even when determining that the print data is received (S109: YES), the control section 11 does not execute printing (S110).

In the first mode, the control section 11 does not execute printing even when determining that the print data is received, and thereby, the power supply section 14 may supply power to the first smart device 2. Even when receiving a linefeed command or a cutter command, similarly, the control section 11 does not execute processing. The print data, the linefeed command, and the cutter command not executed by the control section 11 are stored in the memory section 12.

When determining that the print data is not received (S109: NO), the control section 11 waits for reception of the print data for a predetermined time. When the print data is not received for the predetermined time, the process exits the loop of (S109: NO) and ends the processing.

### 1-5. Transition Between First Mode and Second Mode

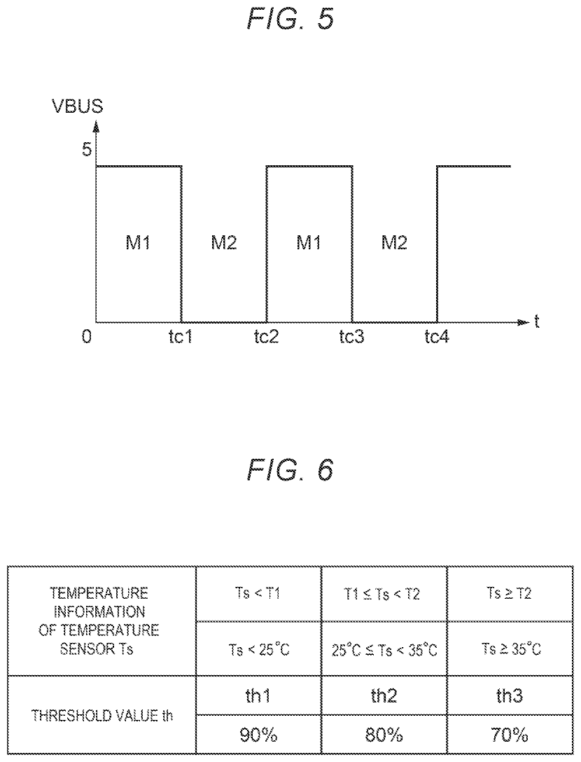

The control section 11 repeatedly executes a series of flowchart shown in FIG. 2. As a result, as shown in FIG. 5, when the first mode is M1 and the second mode is M2, the control section 11 performs processing while transitioning between the first mode M1 and the second mode M2.

In FIG. 5, the vertical axis indicates the voltage of the VBUS output from the first communication section 15 and the horizontal axis indicates time t. When the control section 11 executes the first mode M1, power is supplied to the first smart device 2 by the power supply section 14, and the VBUS indicates 5 V. When the control section 11 executes the second mode M2, power supply to the first smart device 2 by the first communication section 15 is stopped, and the VBUS indicates 0 V.

Referring to the flowchart in FIG. 2, the transition between the first mode M1 and the second mode M2 by the control section 11 in FIG. 5 is explained.

At t=0, if the control section 11 executes the first mode M1 (S108), power supply to the first smart device 2 is continuously executed by the power supply section 14. In this period, the battery of the first smart device 2 is gradually charged. Then, at time tc1, the remaining amount information of the battery reaches the threshold value th or more (S104: YES).

At the time, the control section 11 transitions execution from the first mode M1 to the second mode M2 (S105) and stops power supply to the first smart device 2 by the power supply section 14. When there is print data received by the control section 11, but not executed in the first mode M1, the data is stored in the memory section 12. The control section 11 reads the print data stored in the memory section 12 and executes printing by controlling the printing section 17 (S107). The control section 11 similarly executes processing for a linefeed command or a cutter command received, but not executed.

When the control section 11 executes the second mode M2 and the power supply to the first smart device 2 by the power supply section 14 is continuously stopped, the battery of the first smart device 2 is gradually discharged. Then, the remaining amount information of the battery becomes below the threshold value th at time tc2 (S104: NO).

At the time, the control section 11 transitions execution from the second mode M2 to the first mode M1 (S108) and starts power supply to the first smart device 2 by the power supply section 14.

Similarly, the control section 11 transitions execution from the first mode M1 to the second mode M2 at time tc3 and transitions execution from the second mode M2 to the first mode M1 at time tc4.

While transitioning between the first mode M1 and the second mode M2, the control section 11 receives the status command from the first smart device 2 on the regular basis, acquires the battery temperature information Tb (S101), dynamically changes the threshold value th (S103), controls power supply to the first smart device 2, and thereby, suppresses deterioration of the battery.

### 1-6. Acquisition of Temperature Information by Temperature Sensor

In the above described example of the flowchart in FIG. 2, the battery temperature information is acquired from the received status command.

The control section 11 may acquire the temperature information from the temperature sensor 13 instead. The control section 11 may promptly acquire the temperature information without communication with the first smart device 2.

A case where the control section 11 acquires the temperature information from the temperature sensor 13 will be explained with reference to FIG. 6.

When the control section 11 acquires the temperature information from the temperature sensor 13, the control section 11 determines the threshold value th as shown in FIG. 6 based on the acquired temperature information.

In the example of FIG. 6, a range of temperature information Ts of the temperature sensor 13 is divided into three ranges lower than T1, equal to or higher than T1 and lower than T2, and equal to or higher than T2 from the lower temperature. In this example, T1 indicates 25° C. and T2 indicates 35° C. The threshold values th corresponding to the three ranges of the temperature information Ts of the temperature sensor 13 are respectively 90%, 80%, 70%. These values showing the relationship between Ts and th are stored in the memory section 12. Note that the temperature information Ts of the temperature sensor 13 represents the surrounding temperature and is not affected by the temperature rise of the battery during charging, and thus, T2, 35° C. of the temperature sensor 13 is lower than T2, 45° C. of the battery temperature information Tb.

As shown in FIG. 6, the control section 11 sets the threshold value th to be smaller as the temperature information Ts of the temperature sensor 13 is higher within a range less than the maximum value of the remaining amount information, and early stops charging of the battery.

In the case where the temperature information Ts is acquired from the temperature sensor 13, like the case where the above described battery temperature information Tb is acquired, as shown in FIG. 4, the control section 11 sets the threshold value th to be smaller with the rise of the temperature represented by the temperature information Ts of the temperature sensor 13 with the lapse of time t.

As described above, the control section 11 may dynamically change the threshold value th when acquiring the temperature information Ts from the temperature sensor 13.

### 2. Embodiment 2

The printer 1 can supply power to the first smart device 2 using the first communication section 15 via the communication cable 3, and can further communicate with another second smart device 6 using the second communication section 16. The second smart device 6 is e.g. a smartphone or a tablet.

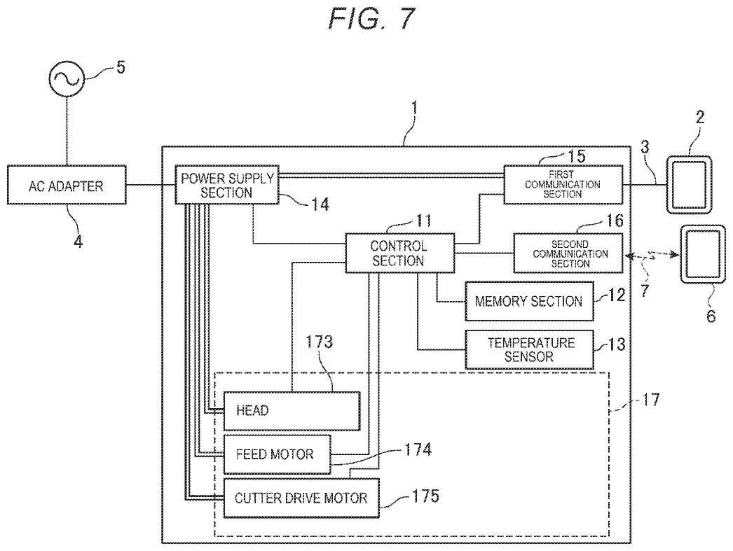

Specifically, as shown in FIG. 7, the printer 1 can communicate with the second smart device 6 as a second terminal device using the second communication section 16 via a wireless communication channel 7. The second communication section 16 is a communication circuit with a wireless communication IC mounted thereon, and communicates according to a standard e.g. Wi-Fi (registered trademark), Bluetooth (registered trademark), wireless Ethernet (registered trademark), or the like.

In the flowchart of FIG. 2, embodiment 2 is different from embodiment 1 in that the print data is received from the second smart device 6, not from the first smart device 2.

Embodiment 2 will be explained according to the flowchart in FIG. 2 with a focus on the differences from embodiment 1.

When executing the second mode in which the control section 11 does not supply power from the power supply section 14 to the first smart device 2 via the first communication section 15 (S105), the control section 11 determines whether or not the print data is received from the second smart device 6 by the second communication section 16 (S106). When receiving the print data from the second smart device 6, the second communication section 16 stores the data in the memory section 12.

When determining that the print data is received from the second smart device 6 by the second communication section 16 (S106: YES), the control section 11 reads the print data from the memory section 12, executes printing by controlling the printing section 17, and prints characters and images on thermal paper (S107).

In the second mode, the power supply section 14 does not supply power to the first smart device 2 and has sufficient power to operate the printing section 17. Therefore, the control section 11 may execute printing by controlling the printing section 17 based on the print data received from the second smart device 6.

When determining that the print data is not received from the second smart device 6 by the second communication section 16 (S106: NO), the control section 11 waits for reception of the print data for a predetermined time. When the print data is not received for the predetermined time, the process exits the loop of (S106: NO) and ends the processing.

On the other hand, when executing the first mode in which the control section 11 supplies power from the power supply section 14 to the first smart device 2 via the first communication section 15 (S108), the control section 11 determines whether or not print data is received from the second smart device 6 by the second communication section 16 (S109). The second communication section 16 receives the print data from the second smart device 6 and stores the data in the memory section 12.

In the first mode, the control section 11 does not execute printing (S110) even when determining that the print data is received from the second smart device 6 by the second communication section (S106: YES).

The print data received but not executed in the first mode is read out from the memory section 12 and printing is executed when the control section 11 transitions from the first mode to the second mode.

When determining that the print data is not received from the second smart device 6 by the second communication section 16 (S109: NO), the control section 11 waits for reception of the print data for a predetermined time. When the print data is not received for the predetermined time, the process exits the loop of (S109: NO) and ends the processing.

Even when the printer 1 can supply power to the first smart device 2 and can further communicate with the other second smart device 6 as in embodiment 2, the temperature information may be acquired, the threshold value th may be dynamically changed, the power supply to the first smart device 2 may be controlled, and deterioration of the battery may be suppressed.

According to the embodiment, the following effects may be obtained.

The printer 1 according to the embodiment includes the power supply section 14, the first communication section 15 configured to make wired communication with the first smart device 2 having the battery and supply power from the power supply section 14 to the first smart device 2, the printing section 17 that performs printing, and the control section 11, and the control section 11 acquires the temperature information, acquires the remaining amount information of the battery from the first smart device 2 using the first communication section 15, dynamically changes the threshold value th based on the acquired temperature information in the range less than the maximum value of the remaining amount information, when the remaining amount information is less than the threshold value th, executes the first mode in which power is supplied from the power supply section 14 to the first smart device 2 via the first communication section 15 and, when the remaining amount information is equal to or more than the threshold value, executes the second mode in which power is not supplied from the power supply section 14 to the first smart device 2 via the first communication section 15 for a predetermined period.

According to the above described aspect, power is supplied from the printer 1 to the first smart device 2 via the first communication section 15, and the first smart device 2 charges the battery. When fully charged at the higher temperature, the battery is deteriorated. Accordingly, when the remaining amount information of the battery of the first smart device 2 is equal to or more than the threshold value th, the printer 1 stops power supply to the first smart device 2. The printer 1 sequentially changes the threshold value th based on the acquired temperature information within the range less than the maximum value of the fully charged battery. As a result, regarding the battery of the first smart device 2, charging is suppressed at the higher temperature while the full charge is avoided, and thereby, deterioration of the battery may be suppressed.

The control section 11 acquires the temperature information from the first smart device 2 by the first communication section 15.

According to the above described aspect, the control section 11 acquires the temperature of the battery directly from the first smart device 2, and thereby, may perform appropriate control.

The printer 1 includes the temperature sensor 13, and the control section 11 acquires the temperature information from the temperature sensor 13.

According to the above described aspect, the control section 11 acquires the temperature from the temperature sensor 13, and it is not necessary to communicate with the first smart device 2.

When executing the first mode, the control section 11 does not perform printing using the printing section 17 if the print data is received from the first smart device 2 by the first communication section 15 and, when executing the second mode, performs printing using the printing section 17 if the print data is received from the first smart device 2 by the first communication section 15.

According to the above described aspect, the control section 11 may suppress power by performing only one of power supply to the first smart device 2 and printing using the printing section 17, and the compact power supply section 14 may be employed.

The printer 1 includes the second communication section 16 communicable with the second smart device 6 different from the first smart device 2, when executing the first mode, the control section 11 does not perform printing using the printing section 17 if the print data is received from the second smart device 6 by the second communication section 16 and, when executing the second mode, performs printing using the printing section 17 if the print data is received from the second smart device 6 by the second communication section 16.

According to the above described aspect, the control section 11 may perform printing if the print data from the other second smart device 6 is received when coupling to the first smart device 2, but not supplying power to the first smart device 2.

A control method for the printer 1 according to the embodiment is a control method for the printer 1 including the power supply section 14, the first communication section 15 configured to make wired communication with the first smart device 2 having the battery and supply power from the power supply section 14 to the first smart device 2, the printing section 17 that performs printing, and the control section 11, including acquiring the temperature information, acquiring remaining amount information of the battery from the first smart device 2 using the first communication section 15, dynamically changing the threshold value th based on the acquired temperature information in the range less than the maximum value of the remaining amount information, when the remaining amount information is less than the threshold value th, executing the first mode in which power is supplied from the power supply section 14 to the first smart device 2 via the first communication section 15 and, when the remaining amount information is equal to or more than the threshold value, executing the second mode in which power is not supplied from the power supply section 14 to the first smart device 2 via the first communication section 15 for a predetermined period.

According to the above described aspect, the printer 1 sequentially changes the threshold value th based on the acquired temperature information within the range less than the maximum value of the fully charged battery. As a result, regarding the battery of the first smart device 2, charging is suppressed at the higher temperature while the full charge is avoided, and thereby, deterioration of the battery may be suppressed.

As above, these embodiments are described in detail with reference to the drawings, however, the specific configurations are not limited to these embodiments and changes, replacements, deletions, etc. may be made without departing from the scope of the present disclosure.

For example, the first smart device 2 and the second smart device 6 are explained using the examples of the smartphones or tablets, however, may be other portable terminals such as notebook PCs.

In the printer 1, the head 173 is explained using the example of the line thermal head, however, any type of the head 173 may be used. For example, an inkjet head may be employed.

The power supply section 14 is explained using the example in which power supply is received from the AC adapter 4, however, the power supply section 14 may be directly coupled to the commercial alternating-current power supply 5 and, as the so-called built-in power supply, may convert alternating-current power into respective direct-current power and output respective voltages. Or, the power supply section 14 may have power capacity that can supply power to the first smart device 2 and supply power to the printing section 17 at the same time. In this case, the processing not to execute printing in FIG. 2 (S110) may be processing to execute printing while saving power. Printing while saving power refers to e.g. printing at the printing speed of 50% compared to normal printing.

The second communication section 16 is explained using the example of wireless communication, but may be wired communication according to the USB standard or the like.

The values in the table showing the battery temperature information and the threshold values th in FIG. 3 and the values in the table showing the battery temperature information and the threshold values th of the temperature sensor 13 in FIG. 6 can be appropriately converted according to the characteristics of the battery of the first smart device 2.

The printer 1 supplies power from the first communication section 15 to the first smart device 2 via the communication cable 3, however, may supply power to the first smart device 2 by contactless charging. The printer 1 includes a contactless power transmission circuit and the first smart device 2 includes a contactless power reception circuit. The control section 11 of the printer 1 controls the contactless power transmission circuit in place of the power supply section 14 and supplies power in a frequency band of 6.78±0.15 MHz to the contactless power reception circuit of the first smart device 2. In this case, the first communication section 15 may wirelessly communicate like the second communication section 16. The first communication section 15 may acquire the remaining amount information and the temperature information of the battery from the first smart device 2 via wireless communication.

A program for realizing functions of an arbitrary configuration section in the above described apparatus may be recorded in a computer-readable recording medium and the program may be read and executed by a computer system. Here, the apparatus is e.g. the printer 1, the first smart device 2, the second smart device 6, or the like. Note that “computer system” here includes an OS (Operating System) and hardware such as peripherals. Further, “computer-readable recording medium” includes a portable medium such as a flexible disk, a magnetooptical disk, a ROM, or a CD (Compact Disk)-ROM and a memory device such as a hard disk built in the computer system. Furthermore, “computer-readable recording medium” includes a medium that holds a program in a fixed period like a volatile memory inside of a computer system as a server or a client when the program is transmitted via a network such as the Internet or a communication line such as a phone line.

The above described program may be transmitted from a computer system storing the program in a memory device or the like to another computer system via a transmission medium or transmission wave in the transmission medium. Here, “transmission medium” that transmits the program refers to a medium having a function of transmitting information like a network such as the Internet or a communication line such as a phone line.

The above described program may be for realizing part of the above described functions. Further, the above described program may realize the above described functions by a combination with a program already recorded in the computer system, the so-called a difference file or a difference program.

What is claimed is:

1. A printer comprising:
a power supply section;
a first communication section configured to make wired communication with a first terminal device having a battery and supply power from the power supply section to the first terminal device; and
a control section configured to acquire temperature information, change a threshold value based on the acquired temperature information, acquire remaining amount information of the battery from the first terminal device using the first communication section, execute a first mode in which power is supplied from the power supply section to the first terminal device via the first communication section when the remaining amount information is less than the threshold value, and execute a second mode in which power is not supplied from the power supply section to the first terminal device via the first communication section when the remaining amount information is equal to or more than the threshold value.

2. The printer according to claim 1, wherein
the control section acquires the temperature information from the first terminal device by the first communication section.

3. The printer according to claim 1, further comprising a temperature sensor, wherein
the control section acquires the temperature information from the temperature sensor.

4. The printer according to claim 1, wherein
when executing the first mode, the control section does not perform printing by a printing section if print data is received from the first terminal device by the first communication section, and
when executing the second mode, the control section performs printing by the printing section if print data is received from the first terminal device by the first communication section.

5. The printer according to claim 1, further comprising a second communication section communicable with a second terminal device different from the first terminal device, wherein
when executing the first mode, the control section does not perform printing by a printing section if print data is received from the second terminal device by the second communication section, and
when executing the second mode, the control section performs printing by the printing section if print data is received from the second terminal device by the second communication section.

6. A control method for a printer including a power supply section, a first communication section configured to make wired communication with a first terminal device having a battery and supply power from the power supply section to the first terminal device, and a printing section that performs printing, comprising:
acquiring temperature information;
changing a threshold value based on the acquired temperature information;
acquiring remaining amount information of the battery from the first terminal device using the first communication section;
executing a first mode in which power is supplied from the power supply section to the first terminal device via the first communication section when the remaining amount information is less than the threshold value; and
executing a second mode in which power is not supplied from the power supply section to the first terminal device via the first communication section when the remaining amount information is equal to or more than the threshold value.
